(19) United States
(12) Patent Application Publication
(10) Pub. No.: US 2007/0159447 A1
(43) Pub. Date: Jul. 12, 2007

(54) LCD capable of controlling luminance of screen and method for controlling luminance thereof

(75) Inventor: Chang-ik Choi, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/505,431

(22) Filed: Aug. 17, 2006

(30) Foreign Application Priority Data
Jan. 9, 2006 (KR) 2006-2437

(51) Int. Cl. G09G 3/36

(52) U.S. Cl. 345/102

(57) ABSTRACT

Disclosed are a liquid crystal display (LCD) capable of controlling a luminance of a screen and a method for controlling a luminance thereof, which includes a backlight unit irradiating a light on the LCD panel by an input driving current; a driving voltage generating unit generating a driving voltage signal for driving the backlight unit by use of a direct current (DC) voltage corresponding to a preset level of luminance and a predetermined AC (alternate current) voltage; and a backlight controlling unit generating the driving current corresponding to the generated driving voltage signal and supplying to the backlight unit. Accordingly, it is possible to maintain luminance of a screen by driving a backlight by use of a direct current (DC) voltage and an AC (alternate current) voltage.

### CROSS-REFERENCE TO RELATED APPLICATIONS

This application claims benefit under 35 U.S.C. §119(a) of Korean Patent Application No. 2006-2437, filed Jan. 9, 2006, in the Korean Intellectual Property Office, the entire contents of which are incorporated herein by reference.

### BACKGROUND OF THE INVENTION

1. Field of the Invention

The present invention relates to a liquid crystal display (LCD) capable of controlling a luminance of a screen and a method for controlling a luminance thereof. More particularly, the present invention relates to a LCD capable of controlling a luminance of a screen and a method for controlling a luminance thereof, which can maintain uniform luminance of the screen by driving a backlight by use of direct current (DC) voltage and alternating current (AC) voltage.

2. Description of the Related Art

Generally, a liquid crystal display (LCD) has a backlight to help a user see an image displayed on a liquid crystal panel. From the rear of the LCD panel, the backlight irradiates the same amount of lights to all parts of the screen.

However, even if the backlight irradiates the same amount of lights, there are differences in the brightness, between a center and both sides of the screen. In other words, the sides of the screen is darker than the center, and the difference increases in the larger LCDs, because the conventional LCDs do not control the luminance differences occurring in the respective parts of the screen, due to time differences.

In order to solve problems such as the uneven luminance uniformity, the manufacture process should be improved, but it requires high costs. In case that the LCD with the above problem is classified as a defective, yield decreases and the developers will suffer a loss. Accordingly, substantial solutions are required.

### SUMMARY OF THE INVENTION

An aspect of the present invention is to solve at least the above problems and/or disadvantages of the related art and to provide at least the advantages described below. Accordingly, an aspect of the present invention is to provide a liquid crystal display (LCD) capable of controlling a luminance of a screen and a method for controlling a luminance thereof, which can maintain uniform luminance of the screen by removing luminance differences between a center and both sides of the screen.

In order to achieve the above-described aspects of the present invention, there is provided the LCD capable of controlling a luminance of a screen, comprising: a backlight unit irradiating a light on the LCD panel by an input driving current; a driving voltage generating unit generating a driving voltage signal for driving the backlight unit by use of a direct current (DC) voltage corresponding to a preset level of luminance and a predetermined AC (alternate current) voltage; and a backlight controlling unit generating the driving current corresponding to the generated driving voltage signal and supplying to the backlight unit.

The driving voltage signal generating unit combines the AC voltage and the DC voltage and generates the driving voltage signal varying according to time.

The LCD further comprises: a main controlling unit receiving a synchronization signal of an input image signal, judging cycle of the input image signal and supplying to the driving voltage generating unit. The driving voltage generating unit generates the driving voltage signal varying cyclically according to the judged cycle.

The main controlling unit judges a horizontal cycle of the input image signal from a horizontal synchronization signal of the input image signal and outputs the judged horizontal cycle and the preset level of the luminance to the driving voltage generating unit, and the driving voltage signal generating unit generates the AC voltage cyclically repeating according to the judged horizontal cycle and combines the generated AC voltage and the DC voltage corresponding to the output level of the luminance to generate the driving voltage signal.

The main controlling unit controls the driving voltage signal generating unit to generate the driving voltage signal synchronized with one of the horizontal cycle of the image displayed on the LCD panel and the horizontal cycle judged by the horizontal synchronization signal.

The backlight controlling unit generates the driving current where a current corresponding to a center of the LCD panel is lower than a current corresponding to both sides of the LCD panel.

The driving voltage signal generating unit generates an AC voltage in a waveform where a first voltage level corresponding to the center of the LCD panel is higher than a second voltage level corresponding to both sides of the LCD panel.

The driving voltage signal generating unit generates an AC voltage in a wave form where the first voltage level corresponding to the center of the LCD panel is lower than the second voltage level corresponding to both sides of the LCD panel.

The LCD further comprises: a signal processing unit separating the horizontal synchronization signal and the vertical synchronization signal from the input image signal and supplying the separated signal to the main control unit, when the input image signal is a digital signal.

According to one aspect of the present invention, a method for controlling a luminance of a liquid crystal display (LCD) having a backlight unit irradiating a light on a LCD panel displaying an image is provided. The method for controlling a luminance of the LCD, comprises: (a) turning a power on; (b) generating a driving voltage signal for driving the backlight unit by use of a direct current (DC) voltage corresponding a preset level of a luminance and a predetermined AC (alternate current) voltage; (c) generating a driving current corresponding to the generated driving voltage signal and providing to the backlight unit; and (d) irradiating a light corresponding to the supplied driving current on the LCD panel by the backlight unit.

The operation (b) combines the AC voltage and the DC voltage to generate the driving voltage signal varying according to time.

The method for controlling further comprises, after the operation (a): (al) receiving a synchronization signal of an input image signal and judging a cycle of the input image signal; and (a2) outputting the judged cycle and the level of the luminance to the operation (b).

The operation (a1) judges the horizontal cycle of the input image signal from a horizontal synchronization signal of the input image signal, and the operation (b) generates the AC voltage repeating cyclically according to the horizontal cycle judged at the operation (a1) and generates the driving voltage signal by use of the generated AC voltage and the DC voltage corresponding to the output level of the luminance.

The operation (b) generates the driving voltage signal synchronized with one of the horizontal cycle of the image displayed on the LCD panel and the horizontal cycle judged by the horizontal synchronization signal.

The operation (c) generates the driving current where a current corresponding to a center of the LCD panel is lower than a current corresponding to both sides of the LCD panel.

The operation (b) generates an AC voltage in a waveform where a first voltage level corresponding to the center of the LCD panel is higher than a second voltage level corresponding to both sides of the LCD panel.

The operation (b) generates an AC voltage in a waveform where the first voltage level corresponding to the center of the LCD panel is lower than the second voltage level corresponding to both sides of the LCD panel.

According to one aspect of the present invention, a method for controlling a light source in a display, the method comprises: receiving an input image signal; generating a driving signal for driving the light source; driving the light source in accordance with the driving signal; and providing light so as to display the input image on the display, wherein the driving signal comprises of a DC biased AC signal.

The display is an LCD display.

The LCD display is capable of displaying a computer video signal.

The method for controlling further comprises: detecting a synchronizing signal of the input image signal; and synchronizing the driving signal with the detected synchronizing signal.

The synchronizing signal comprises either of vertical or horizontal synchronizing signal.

The driving signal is a voltage signal.

The driving voltage signal is a sine wave signal.

The driving voltage signal is synchronized with the horizontal synchronizing signal of the input image signal so as to have no phase difference with the horizontal sync.

The driving voltage signal has higher voltage value corresponding to the center portion of the image relative to the lateral portions of the image.

The driving step in the method for controlling comprises: generating a driving current signal in accordance with the driving voltage signal; and driving the light source in accordance with the driving current signal.

The driving signal is a sine wave voltage signal.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a block diagram of a liquid crystal display (LCD) capable of controlling a luminance of a screen according to an embodiment of the present invention;

FIGS. 2A and 2C are a waveform chart of a driving voltage signal generated by a driving voltage generating unit of FIG. 1;

FIG. 2B is a waveform chart of a driving current generated by FIGS. 2A or 2C; and

FIG. 3 is a flowchart of a method for controlling a luminance of the LCD of FIG. 1.

### DETAILED DESCRIPTION OF THE EXEMPLARY EMBODIMENTS

Hereinafter, an embodiment of the present invention will be described in detail with reference to the accompanying drawing figures.

In the following description, same drawing reference numerals are used for the same elements even in the different drawings. The specific details described in the exemplary embodiments are simply provided to assist in the comprehensive understanding of the invention. The present invention can be carried out without those specific details. Also, well-known functions or constructions are not described in detail since they would obscure the invention in unnecessary detail.

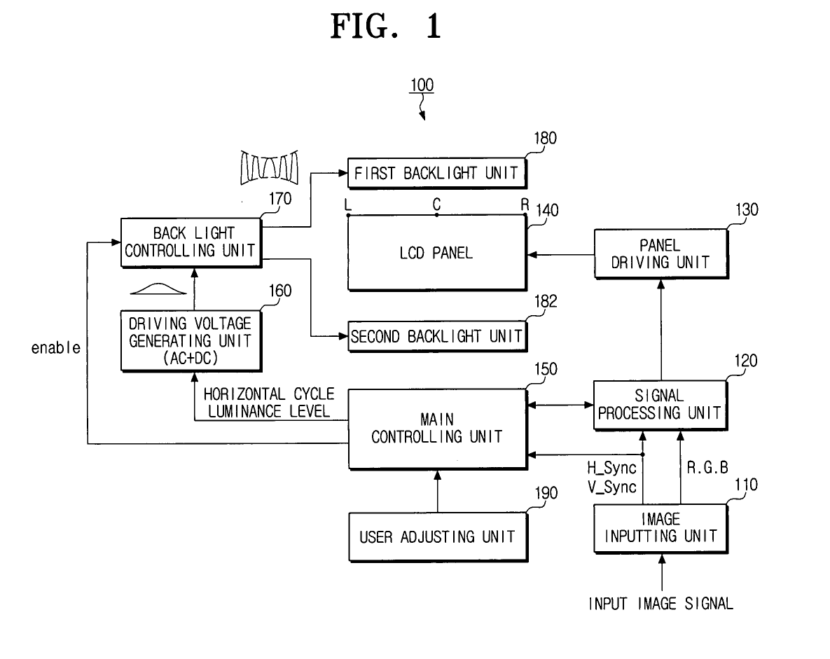

FIG. 1 is a block diagram of a liquid crystal display (LCD) capable of controlling a luminance of a screen according to an embodiment of the present invention.

Referring to FIG. 1, the LCD 100 includes an image inputting unit 110, a signal processing unit 120, a panel driving unit 130, a LCD panel 140, a main controlling unit 150, a driving voltage generating unit 160, a backlight controlling unit 170, a first and second backlight units 180 and 182, and a user adjusting unit 190.

The image inputting unit 110 may be an interface receiving an image signal from a signal source. For example, when the image signal is input from a video card of a computer, the input image signals are R, G and B signals, and have a horizontal synchronization signal (H_Sync) and a vertical synchronization signal (V_Sync). Accordingly, the image inputting unit 110 provides the R, G and B signals to the signal processing unit 120 and provides the main controlling unit 150 with the H_Sync and the V_Sync of the input image signal.

The signal processing unit 120 processes the input image signal provided form the image inputting unit 110 in consideration of the features of the LCD panel 140. For example, the signal processing unit 120 performs proper conversion of signal processing such as conversion of the input image signal into a digital signal, gamma compensation, luminance compensation and scaling, and provides the signal to the panel driving unit 130.

The signal processing unit 120 separates the input image signal into a digital image signal, H_Sync and V_Sync by a TMDS (transition minimized differential signaling) apparatus (not shown), when the input image signal is the digital signal transmitted by a DVI (digital visual interface). The signal processing unit 120 processes the separated digital image signal and provides to the panel driving unit 130, and provides the main controlling unit 150 with the separated H_Sync and V_Sync.

The panel driving unit 130 properly converts the input image signal from the signal processing unit 120 in accordance with the structure of the LCD panel 140, and drives the LCD panel 140 such that the converted signal is displayed on the LCD panel 140.

The LCD panel 140 may be a TFT-LCD (thin film transistor liquid crystal display), and displays the signal converted by the panel driving unit 130 as a viewable image.

The main controlling unit 150 outputs an enable signal to the backlight controlling unit 170, when power is on. The enable signal is a control signal to turn on or off the backlight controlling unit 170.

The main controlling unit 150 receives a synchronization signal from the image inputting unit 110, judges a cycle of the input image signal and provides the judged cycle to the driving voltage generating unit 160. The judged cycle is used for synchronization of frequency or alternating current (AC) voltage at the driving voltage generating unit 160 which will be described below.

More particularly, the main controlling unit 150 judges a horizontal cycle of the input image signal from a frequency of the input H_Sync, and judges a vertical cycle of the input image signal from a frequency of the inout V_Sync. For example, the main controlling unit 150 calculates the horizontal cycle corresponding to 60 KHz when the H_Sync is 60 KHz, and calculates the vertical cycle corresponding to 60 Hz when the vertical synchronization signal is 60 Hz.

The main controlling unit 150 outputs the judged horizontal cycle, the judged vertical cycle and a preset level of luminance to the driving voltage generating unit 160. The preset level of luminance is adjusted by the user adjusting unit 190 at the LCD 100, and may be changeable by the user.

In case of the H_Sync, an image is irradiated on a screen of the LCD panel 140 by the unit of lines, so the horizontal cycle stays constant. However, the V_Sync changes every time the image is irradiated by the line unit, so the vertical cycle decreases. Accordingly, the main controlling unit 150 outputs the vertical cycle which may be periodically changed according to the horizontal cycle, and the constant horizontal cycle.

The main controlling unit 150 controls the driving voltage generating unit 160 to generate the driving voltage signal synchronized with the horizontal cycle judged by the H_Sync or the horizontal cycle of the image displayed on the LCD panel 140. The driving voltage signal is used as a signal for controlling a luminance of a screen.

The driving voltage generating unit 160 combines direct current (DC) voltage corresponding to the preset level of luminance provided from the main controlling unit 150, with a predetermined AC (alternating current) voltage, and generates the driving voltage signal for driving the first and second backlight units 180 and 182.

More particularly, the driving voltage generating unit 160 generates the AC voltage repeating cyclically according to the judged time, that is, horizontal cycle, and generates the DC voltage corresponding to the preset level of luminance, and combines the generated AC voltage and DC voltage to generate the driving voltage signal.

Herein, the driving voltage generating unit 160 uses the DC voltage in inverse proportion to the level of luminance. In order to generate the brighter level, the lower DC voltage is used by the driving voltage generating unit 160, and in order to generate the darker level, the bigger DC voltage is used by the driving voltage generating unit 160. This is because the backlight controlling unit 170 to be described below is designed to generate the driving current in reverse proportion to the driving voltage signal. The driving voltage generating unit 160 synchronizes the AC voltage with the horizontal cycle judged by the H_Sync or the horizontal cycle of the image displayed on the LCD panel 140, and repeats synchronization according to the horizontal cycle. Needless to say, the DC voltage may be implemented in an inverse manner to adjust the luminance level.

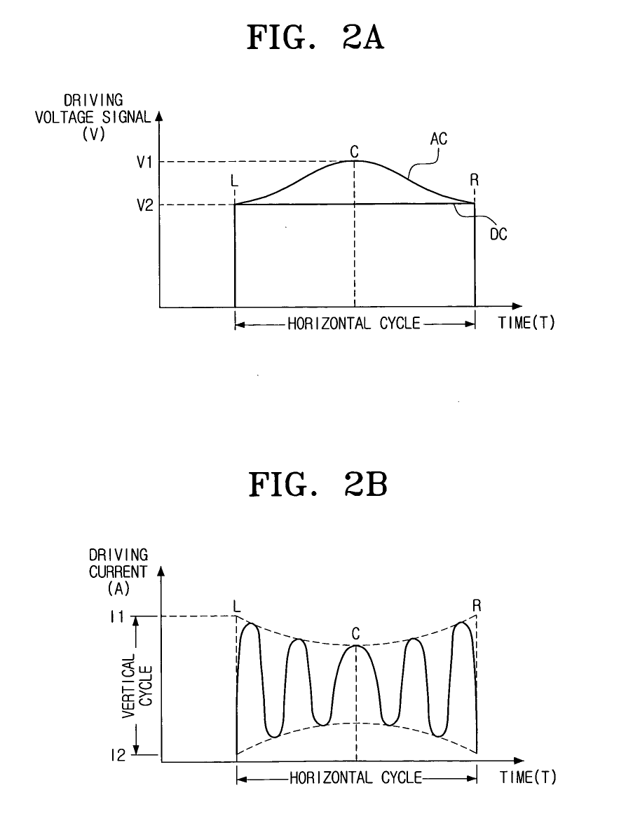

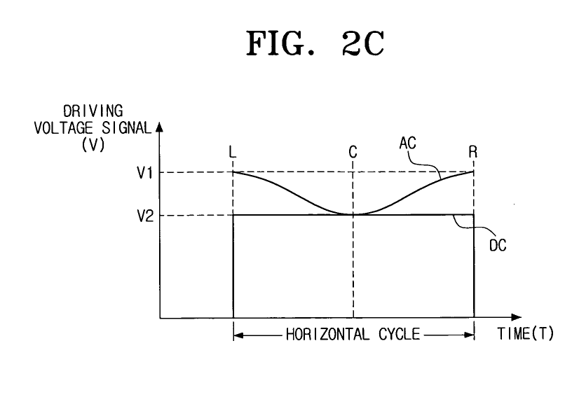

FIG. 2A is a waveform chart provided to explain the driving voltage signal generated by the driving voltage generating unit of FIG. 1.

Referring to FIGS. 1 and 2A, the driving voltage generating unit 160 generates the driving voltage signal in a sine waveform repeating cyclically according to the horizontal cycle. ‘C’ is a relative position corresponding to the central part of the LCD panel 140, ‘L’ is a relative position corresponding to a left side of the LCD panel 140, R is a relative position corresponding to a right side of the LCD panel 140 and one horizontal cycle corresponds to the time in which a single line of image is expressed from L from R.

The driving voltage generating unit 160 cyclically generates the AC voltage in waveform where the first voltage level (V1) corresponding to C is higher than the second voltage level (V2) corresponding to R and L, and combines the AC voltage with the DC voltage to generate a driving voltage signal. The driving voltage generating unit 160 synchronizes a starting point of the generated driving voltage signal with L. The driving voltage generating unit 160 synchronizes a cycle of the generated driving voltage signal with at least one of the H-Sync and V_Sync.

The driving voltage generating unit 160 outputs the driving voltage signal illustrated in FIG. 2A to the backlight controlling unit 170.

The backlight controlling unit 170 receives the driving voltage signal and generates a driving current, which is AC pulse of high driving voltage for driving the first and second backlight units 180 and 182. The backlight controlling unit 170 generates lower driving current as the higher voltage level is input.

FIG. 2B is a waveform provided to explain the driving current output from the backlight controlling unit of FIG. 1.

Referring to FIG. 2B, the backlight controlling unit 170 generates, from the driving voltage signal, the driving current where the first current (I1) corresponding to C of the LCD panel 140 is lower than the second current corresponding R and L of the LCD panel 140. That is, the backlight controlling unit 170 generates lower driving current as the higher voltage level is input. The backlight controlling unit 170 outputs the driving current generated as shown in FIG. 2B to the first and second backlight units 180 and 182. The driving current output from the backlight controlling unit 170 may decrease according to the vertical cycle declining as the time elapses.

By the driving current output from the backlight controlling unit 170, the first and second backlight units 180 and 182 irradiate light, to the LCD panel 140 with degrees varying according to time. The current decreases as it goes L to C of the LCD panel 140 and increases as it goes from C to R, so C has lower level of light than R and L. Accordingly, the LCD panel 140 has uniform level of luminance. According to the embodiment of the present invention, two backlight units 180 and 182 are exemplified, but various changes in form and details may be made, and therefore, one or more than two backlight units may be provided.

The adjusting unit 190 has a plurality of buttons for selecting a function supported by the LCD 100, and supplies to the main controlling unit 150 a signal corresponding to the button selected by the user. The user adjusting unit 190 may be provided on a main body of the LCD 100 or be a remote controller.

According to one embodiment of the present invention, the user adjusting unit 190 has a function of adjusting luminance of an image displayed on the LCD panel 140. For example, the luminance of the image may be set to five levels. If the user requests the user adjusting unit 190 to brighten the image, the main controlling unit 150 provides the driving voltage generating unit 160 with a requested level of luminance. The driving voltage generating unit 160 uses DC voltage lower than a previous voltage to generate the driving voltage signal, as the requested level of luminance is brighter than the previous level. The backlight controlling unit 170 is designed such that as the lower driving voltage signal is input, the more driving current is output. Accordingly, the backlight controlling unit 170 outputs to the first and second backlight units 180 and 182 a driving current in a parabolic waveform having a larger amplitude than the previous amplitude.

When the backlight controlling unit 170 is designed to generate the driving current in proportion to a voltage level, the driving voltage generating unit 160 generates a driving voltage signal in a cosine waveform as illustrated in 2C.

The driving voltage signal illustrated in FIG. 2C is generated by using the DC voltage in proportion with level of luminance and the AC voltage synchronized with the horizontal cycle. That is, the driving voltage generating unit 160 generates the driving voltage signal by use of the DC voltage. The higher DC voltage is used to generate the brighter level luminance and, the lower DC voltage is used to generate the darker level luminance at the driving voltage generating unit 160. Reference numbers in FIG. 2C are the same as FIG. 2A, so detailed description will be omitted.

When the driving voltage generating unit 160 outputs the driving voltage signal as illustrated in FIG. 2C, the backlight controlling unit 170 generates the driving current in proportion to the voltage level as illustrated in FIG. 2B. The backlight controlling unit 170 generates the driving current as illustrated FIG. 2B and outputs the generated driving current to the first and second backlight controlling unit 170.

According to the embodiment of the present invention, the driving voltage generating unit 160 generates the AC voltage in accordance with the cycle of the image displayed on the LCD panel 140, and generates the driving voltage signal by combining the generated AC voltage and a predetermined level of DC voltage. The backlight controlling unit 170 generates the driving current corresponding to the driving voltage signal, and drives the first and second backlight units 180 and 182 with the generated driving current varying degrees according to the respective portions of the LCD panel 140. Accordingly, it is possible to solve the irregular problem of luminance of the prior art.

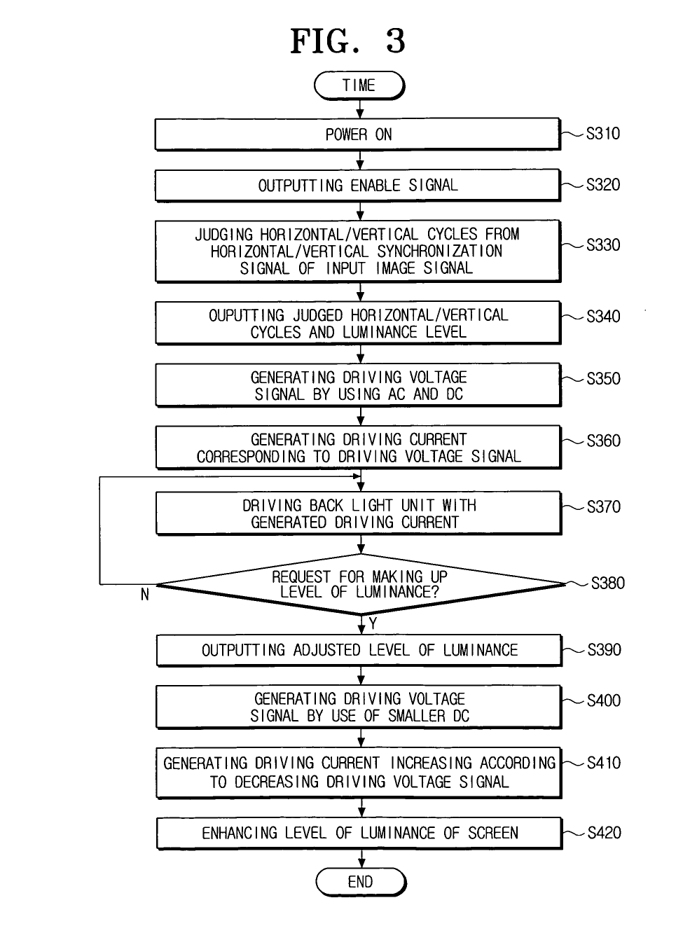

FIG. 3 is a flowchart provided to explain a method for controlling the luminance of the LCD of FIG. 1.

FIG. 3 exemplifies that the driving voltage generating unit 160 generates the driving voltage signal in the sine waveform by use of the DC voltage in inverse proportion to the adjusted level of luminance, and the backlight controlling unit 170 generates the driving current in the parabolic waveform in inverse proportion to the voltage level.

Referring to FIGS. 1 through 3, when power is on, the main controlling unit 150 outputs to the backlight controlling unit 170, an enable signal for turning on the backlight controlling unit 170 (S310 and S320). The main controlling unit 150 receives a synchronization signal and judges the cycle of the image signal. The main controlling unit 150 outputs the judged cycle and a preset level of luminance to the driving voltage generating unit 160 (S330 and S340).

At operations S330 and S340, the synchronization signal is input from the image inputting unit 110 or the signal processing unit 120, and includes H-Sync and V_Sync. The main controlling unit 150 judges the horizontal cycle and the vertical cycle from the frequencies of H-Sync and V_Sync, respectively, and provides the result to the driving voltage generating unit 160 together with the preset level of luminance. The main controlling unit 150 outputs the constant horizontal cycle and the vertical cycle changing cyclically according to the horizontal cycle.

After operation S340, the driving voltage generating unit 160 combines the DC voltage corresponding to the preset level of luminance provided from the operation of S340, with a predetermined AC voltage, to generate a driving voltage signal for driving the first and second backlight units 180 and 182 (S350).

At operation S350, the driving voltage generating unit 160 generates an AC voltage repeating cyclically according to the judged horizontal cycle, and generates a DC voltage corresponding to the preset level of luminance. The driving voltage generating unit 160 combines the generated AC voltage and DC voltage, to generate a driving voltage signal as illustrated in FIG. 2A. The driving voltage generating unit 160 uses the DC voltage in inverse proportion to the level of luminance. That is, the brighter level is requested, the lower DC voltage is used by the driving voltage generating unit 160, because the lower DC voltage is used, the more driving current is generated by the backlight controlling unit 170 to drive the first and second backlight units 180 and 182. The driving voltage generating unit 160 generates a driving voltage signal in which the AC voltage is synchronized with the horizontal cycle.

After operation 350, the backlight controlling unit 170 receives the generated driving voltage signal and generates the driving current for driving the first and second backlight units 180 and 182 (S360). Accordingly, the backlight controlling unit 170 drives the first and second backlight units 180 and 182 by use of the generated driving current (S370). The backlight controlling unit 170 generates a driving current which is decreased as higher voltage level is input.

Accordingly, the first and second backlight units 180 and 182 irradiate lights to the LCD panel 140 with varying levels according to time by the driving current output from the backlight controlling unit 170. The driving current decreases as it goes closer to the center from the left side of the LCD panel 140, and increases as it approaches the right side from the center. As a result, the LCD panel 140 has overall uniform luminance.

If the level of luminance is requested to be adjusted by the user adjusting unit 190 after a predetermined time and thus, ‘up’ signal is received for requesting a brighter level, the main controlling unit 150 provides the driving voltage generating unit 160 with the adjusted level of luminance (S380 and S390).

Since the level of luminance requested at operation S390 is higher than the level generated at operation S340, the driving voltage generating unit 160 generates the driving voltage signal by use of the DC voltage lower than that used at operation S350 (S400). As explained above, the backlight controlling unit 170 is designed such that the more driving current is output as the driving voltage signal has lower voltage.

After operation S400, the backlight controlling unit 170 generates the driving current of a larger amplitude than that of the operation S360, to drive the first and second backlight units 180 and 182 (S410). As the first and second backlight units 180 and 182 irradiate light by use of increased driving current, overall luminance or luminance of the screen of the LCD panel 140 improves.

The control method according to exemplary embodiment of the present invention was explained above with reference to FIGS. 2A and 2B, but it is also possible to drive the first and second backlight units 180 and 182 by generating the driving voltage signal as illustrated in FIG. 2C and using the driving current as illustrated in FIG. 2B.

In the above-explained embodiment of the present invention, the main controlling unit 150 and the driving voltage generating unit 160 are separately provided, but it will be appreciated that the two may be integrally formed in one chip.

According to one aspect of the present invention, the DC voltage corresponding to the adjusted luminance level may be stored in a built-in memory of the driving voltage generating unit 160.

With the LCD capable of controlling a luminance of a screen and a method for controlling a luminance as explained above with reference to a few exemplary embodiments of the prevent invention, it is possible to maintain the uniform luminance of the screen by driving the backlight unit 180 using DC and AC voltages.

More particularly, the backlight unit 180 maintains uniform screen luminance by the driving current which has high-voltage sine wave and a predetermined cycle, and varies according to the screen. That is, according to the present invention, the driving current corresponding to both sides of the screen flows at a higher rate than the driving current corresponding to the center of the screen, and luminance differences between the center and both sides of the screen are compensated.

Also, enhanced quality image is provided by using the screen luminance controlling signal synchronized with the image signal input from the signal source.

While the invention has been shown and described with reference to certain embodiments thereof, it will be understood by those skilled in the art that various changes in form and details may be made therein without departing from the spirit and scope of the invention as defined by the appended claims.

What is claimed is:

1. A liquid crystal display (LCD) displaying an image on a LCD panel, the LCD capable of controlling a luminance of a screen, comprising:
a backlight unit irradiating a light on the LCD panel by an input driving current;
a driving voltage generating unit generating a driving voltage signal for driving the backlight unit by use of a direct current (DC) voltage corresponding to a preset level of luminance and a predetermined AC (alternate current) voltage; and
a backlight controlling unit generating the driving current corresponding to the generated driving voltage signal and supplying to the backlight unit.

2. The LCD of claim 1, wherein the driving voltage signal generating unit combines the AC voltage and the DC voltage and generates the driving voltage signal varying according to time.

3. The LCD of claim 1, further comprising:
a main controlling unit receiving a synchronization signal of an input image signal, judging cycle of the input image signal and supplying to the driving voltage generating unit,
wherein the driving voltage generating unit generates the driving voltage signal varying cyclically according to the judged cycle.

4. The LCD of claim 3, wherein the main controlling unit judges a horizontal cycle of the input image signal from a horizontal synchronization signal of the input image signal and outputs the judged horizontal cycle and the preset level of the luminance to the driving voltage generating unit, and
the driving voltage signal generating unit generates the AC voltage cyclically repeating according to the judged horizontal cycle and combines the generated AC voltage and the DC voltage corresponding to the output level of the luminance to generate the driving voltage signal.

5. The LCD of claim 4, wherein the main controlling unit controls the driving voltage signal generating unit to generate the driving voltage signal synchronized with one of the horizontal cycle of the image displayed on the LCD panel and the horizontal cycle judged by the horizontal synchronization signal.

6. The LCD of claim 1, wherein the backlight controlling unit generates the driving current where a current corresponding to a center of the LCD panel is lower than a current corresponding to both sides of the LCD panel.

7. The LCD of claim 6, wherein the driving voltage signal generating unit generates an AC voltage in a waveform where a first voltage level corresponding to the center of the LCD panel is higher than a second voltage level corresponding to both sides of the LCD panel.

8. The LCD of claim 6, wherein the driving voltage signal generating unit generates an AC voltage in a wave form where a first voltage level corresponding to the center of the LCD panel is lower than a second voltage level corresponding to both sides of the LCD panel.

9. The LCD of claim 4, further comprising:
a signal processing unit separating the horizontal synchronization signal and the vertical synchronization signal from the input image signal and supplying the separated signal to the main controlling unit, when the input image signal is a digital signal.

10. A method for controlling a luminance of a liquid crystal display (LCD) having a backlight unit irradiating a light on a LCD panel displaying an image, the method for controlling a luminance of the LCD, comprising:
(a) turning a power on;
(b) generating a driving voltage signal for driving the backlight unit by use of a direct current (DC) voltage corresponding a preset level of a luminance and a predetermined AC (alternate current) voltage;
(c) generating a driving current corresponding to the generated driving voltage signal and providing to the backlight unit; and
(d) irradiating a light corresponding to the supplied driving current on the LCD panel by the backlight unit.

11. The method for controlling of claim 10, wherein the operation (b) combines the AC voltage and the DC voltage to generate the driving voltage signal varying according to time.

12. The method for controlling of claim 10, further comprising, after the operation (a):
(a1) receiving a synchronization signal of an input image signal and judging a cycle of the input image signal; and
(a2) outputting the judged cycle and the level of the luminance to the operation (b).

13. The method for controlling of claim 12, wherein the operation (a1) judges the horizontal cycle of the input image signal from a horizontal synchronization signal of the input image signal, and
the operation (b) generates the AC voltage repeating cyclically according to the horizontal cycle judged at the operation (a1) and generates the driving voltage signal by use of the generated AC voltage and the DC voltage corresponding to the output level of the luminance.

14. The method for controlling of claim 13, wherein the operation (b) generates the driving voltage signal synchronized with one of the horizontal cycle of the image displayed on the LCD panel and the horizontal cycle judged by the horizontal synchronization signal.

15. The method for controlling of claim 10, wherein the operation (c) generates the driving current where a current corresponding to a center of the LCD panel is lower than a current corresponding to both sides of the LCD panel.

16. The method for controlling of claim 15, wherein the operation (b) generates an AC voltage in a waveform where a first voltage level corresponding to the center of the LCD panel is higher than a second voltage level corresponding to both sides of the LCD panel.

17. The method for controlling of claim 15, wherein the operation (b) generates an AC voltage in a waveform where the first voltage level corresponding to the center of the LCD panel is lower than the second voltage level corresponding to both sides of the LCD panel.

18. A method for controlling a light source in a display, the method comprising:
receiving an input image signal;
generating a driving signal for driving the light source;
driving the light source in accordance with the driving signal; and
providing light so as to display the input image on the display;
wherein the driving signal comprises of a DC biased AC signal.

19. The method according to claim 18, wherein the display is an LCD display.

20. The method according to claim 19, wherein the LCD display is capable of displaying a computer video signal.

21. The method according to claim 18, further comprising the steps of:
detecting a synchronizing signal of the input image signal; and
synchronizing the driving signal with the detected synchronizing signal.

22. The method according to claim 21, wherein the synchronizing signal comprises either of vertical or horizontal synchronizing signal.

23. The method according to claim 22, wherein the driving signal is a voltage signal.

24. The method according to claim 23, wherein the driving voltage signal is a sine wave signal.

25. The method according to claim 24, wherein the driving voltage signal is synchronized with the horizontal synchronizing signal of the input image signal so as to have no phase difference with the horizontal sync.

26. The method according to claim 25, wherein the driving voltage signal has higher voltage value corresponding to the center portion of the image relative to the lateral portions of the image.

27. The method according to claim 27, wherein in the driving step comprises of:
generating a driving current signal in accordance with the driving voltage signal; and
driving the light source in accordance with the driving current signal.

28. The method according to claim 18, wherein the driving signal is a sine wave voltage signal.
